(19) United States
(12) Patent Application Publication
(10) Pub. No.: US 2011/0119344 A1
(43) Pub. Date: May 19, 2011

(54) Apparatus And Method For Using Distributed Servers As Mainframe Class Computers

(76) Inventor: Susan Eustis, (US)

(21) Appl. No.: 12/620,579

(22) Filed: Nov. 17, 2009

(51) Int. Cl. G06F 15/167

(52) U.S. Cl. 709/213

(57) ABSTRACT

The invention consists of a switch or bank of switches that give hundreds or thousands of servers the ability to share memory efficiently. It supports improving distributed server utilization from 10% on average to 100%. The invention consists of connecting distributed servers via a cross point switch to a back plane shared random access (RAM) memory thereby achieving a mainframe class computer. The distributed servers may be Windows PCs or Linux standalone computers. They may be clustered or virtualized. This use of cross point switches provides shared memory across servers, improving performance.

### SUMMARY OF INVENTION

The present invention relates to systems for processing information in a data center using high speed processors in an efficient manner. Through extending the amount of memory available to a server to create a large block of shared memory, the processing environment can be managed in a more efficient manner. By locating a backplane of shared memory outside the server rack or group of blade racks the high speed processing of information uses existing resources better. More specifically, the present invention relates to an apparatus for using crosspoint switches to share memory between servers in a data center to facilitate higher utilization of existing distributed server processors.

The application processing is a combination of software running on the server and use of a database to store the information being processed. Efficient IT server operation depends on efficient use of RAM memory and cache memory. RAM and cache memory is used to store the information being processed and the instructions used to process information in a manner so that intermediate calculations can be performed on data that is immediately available. Memory is used by the processor to operate on the data using an instruction set for operations controlled by software.

Software dictates how servers process information according to instructions and how servers send and receive queries from a database. Processing of data in a server uses RAM memory associated with a particular server or perhaps one overflow server to achieve rapid processing of information. Servers send and receive information using I/O ports that provide digital streams from the InterNET 40 or an internal enterprise NET 40work. The InterNET 40 streams can be from a private or public NET 40work.

Once this NET 40work data is in the machine, a processor chip is used to perform calculations and data manipulations based on instructions contained in the software and the processor instruction set. The problem is that as the server systems perform processing in the form of queries or instruction set manipulation of digital content on data located in RAM memory, there is not enough memory in any one or two linked servers to prevent the servers from crashing when they run out of memory during heavy processing loads. The problem solved by the invention is to make the servers more efficient inside the server as the systems perform these processing operations. Memory is too expensive to load if it is not going to be used 99.999% of the time. As much memory as a processor might need under a heavy load, the memory would be wasted much of the time. So the workload on the processors is limited to 10% of the processor capability to prevent server crashes due to lack of memory.

Efficient processing depends on the server having ready access to information containing the pointers to the memory allocated to a particular server and the query. Static use of the RAM memory both in the server and on the shared backplane memory occurs in a manner that is transparent to the processor for a particular processing task. The invention is able to prevent system crashes because of lack of memory by providing a large shared memory that is divided into blocks used by different servers. When a task has been completed, the dynamic backplane RAM memory block is marked as empty and can be reallocated and accessed as needed from a different server using the crosspoint switch.

### BACKGROUND OF THE INVENTION

The Internet is the driving force in data processing, the quantities of data generated in a year far surpassing all the information contained in the U.S. Library of Congress and the quantities of data doubling every 7 months. The quantity of digital video and image information creates needs for fast switching devices in the network. Crosspoint switches hare emerged in this data intensive environment providing a relatively expensive IC switching device mostly used to pass high speed video and image data across a network. The crosspoint switches can be used to pass data rapidly on a backplane that creates a large block of RAM memory storage in a data center environment. The ability of multiple servers to use one large chunk of RAM memory represents a significant advance in the computing market in the context of the quantities of data being managed.

The Internet and wireless communications dominate communications technology. Wireless web devices, Voice over Internet Protocol (VoIP), video-on-demand, third generation (3G) wireless services increase demand for higher speed, higher bandwidth communications systems. Remote network access has increased network bandwidth requirements and complexity. The continuing adoption of broadband technology is unrelenting.

E-mail, instant messaging, blogging, wikis, and e-commerce originally PC based, are being combined with the increasing availability of next-generation wireless devices. Features include Internet browsing, cameras and video recorders. These initiatives drive data traffic through the NET 40work infrastructure to a data center in a spikey manner. The different types of data transmitted at various speeds over the Internet require service providers and enterprises to invest in multi-service equipment. Broadband equipment is emerging that can securely and efficiently process and transport the varied types of network traffic, regardless of whether it is voice traffic or data traffic. To achieve the performance and functionality required by such systems, original equipment manufacturers (OEMs) utilize complex ICs to address both the cost and functionality of a system.

As a result of the pace of new product introductions in response to the changing market conditions in the telecommunications environments, there is a proliferation of standards. Crosspoint switches are designed to accommodate demands in meeting those standards for data transport and are used to control costs involved in implementing new network systems. Difficulty of designing and producing required ICs has stimulated the market for crosspoint switches. A position has evolved for the semiconductor companies. Equipment suppliers have increasingly outsourced IC design and manufacture to semiconductor firms with specialized expertise.

These trends have created a significant opportunity for data centers to cost-effectively implement solutions for the processing and transport of data in and out of different data centers. Enterprises require computer suppliers that have highly efficient processing systems and that provide computers that can possess at a system-level quickly with high-performance, highly reliable, power-efficient computers.

Cooling is a significant aspect of making the servers work.

### RELATED ART

Traditional servers in a data center are optimized to share memory between generally two servers if at all, while a mainframe class machine implements shared memory. Mainframes have backplane memory that is used by all the processors within the mainframe. This is commonplace in the industry and there is never any confusion as to what is a distributed server and what is a mainframe among knowledgeable IT people. What does not exist is the situation described by the invention whereby many servers share external memory as though it is internal to the server.

Shared memory for a large cluster of servers leads to the concept of the distributed server as a mainframe class computing device. While the distance traveled between servers to the shared memory backplane is a potential problem, there are a significant number of look ahead algorithms available in the industry that can be combined with the apparatus described to build a system that works.

The difference between a server and a mainframe is that a mainframe is constructed to achieve efficient and reliable implementation of shared workload, while servers work independently to achieve efficient processor intensive computing. Servers work perhaps in a virtualized environment, perhaps in clusters, but always where the processor resources are utilized in an efficient manner for particular types of workload. Workload worldwide is divided half-and-half between mainframe class machines and servers.

The multi-core revolution currently in progress in the server environment is making it increasingly important for applications to exploit concurrent execution. A backplane shared memory for a group of servers means all the servers operate concurrently even using different programs and applications, just leveraging the large block of memory available. With optical components and optical memory under development, access times should be speeding up.

In order to take advantage of advances in technology, concurrent software designs and implementations, are evolving.

Transactional memory is a paradigm that allows the programmer to design code as if multiple locations can be accessed and/or modified in a single atomic step, providing the base for the current invention. Transactional memory allows programmers to use blocks, which may be considered sequential code.

The data centers are generally not efficient because the Internet provides very spikey workload and these spikes cause the servers to crash in an unpredictable manner, which operators attribute to the servers running out of memory. The disadvantage of the data servers that are currently in use in data centers is that there is server sprawl. Because the servers generally run at 5% utilization, there is a lot of unused capacity. The servers consume a lot of electricity as documented in the WinterGreen Research ROI and elsewhere. The distributed server based data center runs at 10× less efficiency than a mainframe because of these and other factors.

Unfortunately, as data center servers only run at 5% to 25% capacity typically there is a lot of waste and extra expense associated with servers. IT cannot migrate wholesale to the mainframe because there is a lot of sunk investment in Microsoft based resource, both people skills and software. It has been hoped that VMWare virtualization and similar efforts would improve server efficiency, but this has not been the case with respect to any dramatic improvement. The significant barriers to making the servers work more efficiently are overcome by the new apparatus described hereafter. Single or double application software server memory and cache require servers to failover to other servers when there is too much workload, but often this is an inefficient process because it is software driven.

Virtualized servers that use software like VMWare have typically been thought to overcome these utilization difficulties for servers but have not, due to crashes brought in part by lack of enough memory in the servers. Clusters of servers were developed to make them work more like a mainframe class unit, but again this did not solve the problem of server crashes. Only providing more memory in the form of random access memory and cache has the potential of making the servers function more efficiently, moving them into mainframe class computing environments. State of the art solutions of simply adding more memory to each server do not work, because the needs for memory are dynamic, with the most efficient solution being one whereby memory is available as needed and is dynamically reallocated as needed. It is not efficient or even possible to have lots and lots of memory sitting idle on each server while it is needed elsewhere. It is not efficient to duplicate an entire server software and hardware when all that is needed is more memory. The server processors are running at 30 to 31% capacity when the server crashes. This is with a 4 core processor. 64 core processors are on the announced technology roadmap. Processing power does not appear to be the problem.

When data centers lack effective efficient server processing, they are forced to continue buy more servers sometimes at a rate of 500 per week. The trucks back up to the data center and deliver more servers every week. The Internet provides very spikey workload and these spikes cause the servers to crash in an unpredictable manner. Server utilization remains low because IT directors back off workload trying to keep servers from crashing.

The documented disadvantage of the data center is that there is server sprawl, causing significant drains on power availability because of powering the servers and paying for air conditioning which is typically takes twice the power as the server itself does. Data center space allocation has been improved by loading servers into truck where they are preconfigured and set up to run without being removed from the container when they arrive at the data center. But this does not solve the problem of server sprawl.

IT departments are turning in greater numbers to the mainframe, which is scalable from a remote monitor, no more hardware needs to be added to achieve scalability in most cases.

### BRIEF DESCRIPTION OF THE FIGURES

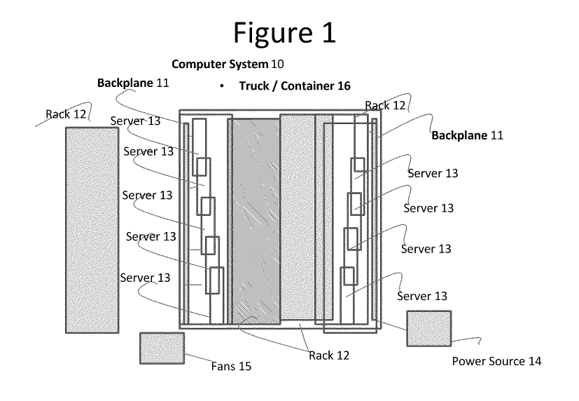

Referring now to FIG. 1, a computer system 10 is shown. The computer system 10 includes a memory backplane 11 and many racks 12 that hold groups of server 13 computers, which are powered, by power sources 14. Fans 15 are used to cool the servers 13. The servers are installed in racks 12 or similar blade chasses 12 and located in a container 16 or data center 16. Cooling in the data center 16 or container 16 is a significant aspect of making the computers work in a reliable manner as operating a computer server 13 causes heat.

What is interesting about this group of servers 13 is that they are preconfigured in a truck container 16 and left in the container 16 when they get to the data center 16. This is common practice in the industry where a company, say Sun Microsystems, now Oracle, packs new servers 13xcompletely configured with software 20 in the container 16. The preconfigured servers 13 have software 20, which can be any kind say, a Microsoft operating system and a IBM WebSphere application server.

The servers 13 packed in a truck container 16, are tested in place so they can be used as soon as they get to the data center. The truck is then shipped to a customer with working servers 13 in the truck container 16. This makes it very convenient to place a shared memory backplane 11 on one side of the truck container 16. Part of the configuration process is then to connect to servers 13 on a line 31 to the memory backplane 11.

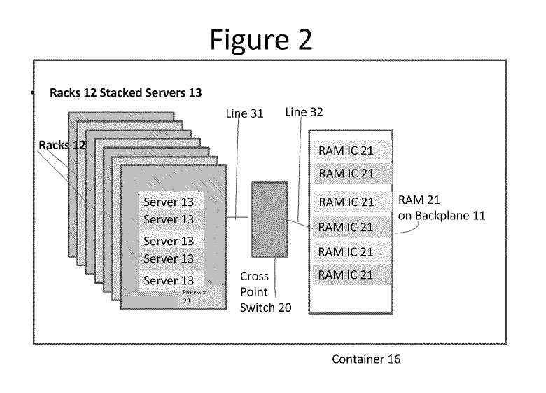

As shown in FIG. 2, the server s 13 in a rack 12 are connected on a line 31 to the crosspoint switch 20 which is connected on a line 32 to the memory integrated circuits 21 located on the memory backplane 11 in the container 16.

The cross point switch 20 is used to route signals on a line 31 from each individual server 13 in a rack 12 to the individual blocks of RAM memory 21 located on a memory backplane 11. Similarly, the cross point switch 20 is used to route signals to each individual RAM memory block 21 on a memory backplane 11 back to the individual server 13, all located in a container 16 or data center 16. In this manner, the system creates a large chunk of memory 11 that can be used by any server 13 connected via the cross point switches 20 to the backplane memory 11. A server 13 may have an Intel or AMD processor 23 and use a Microsoft .NET 40 application development system.

But, there are many other available processors for servers and operating systems, middleware, and applications software in the IT industry. The advantage of this invention is that implementing more intuitive .NET 40 server based systems in a mainframe environment eliminates the complexity of traditional mainframe systems. There is a lot of resource worldwide devoted to understanding how Microsoft systems work. Once there is a large chunk of RAM memory available to the servers 13 mounted in a rack 12, there is the ability to use all the Internet based software that has evolved since 1995 at the time the Internet was starting to be adopted by enterprises and has continued to be adopted.

### EXAMPLE

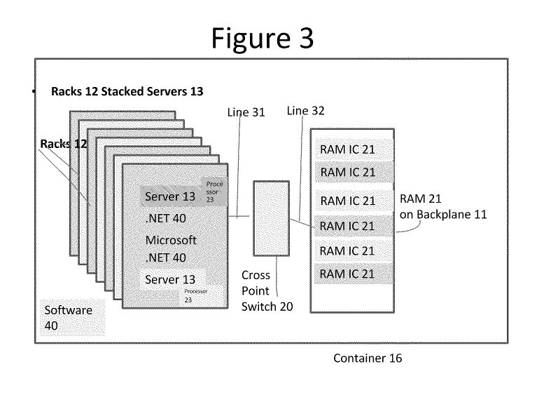

FIG. 3 presents an example of how the embodiment of the present invention works with the server 13 using Microsoft .NET 40 development system in the processor 23. FIG. 3 provides an illustration of how information coming off a crosspoint switch 20 router brings information from the Internet into a clustered server 13 configuration and how the information is distributed to various servers 13 for processing. Distribution to various servers 13 occurs using an application server software 40, perhaps IBM WebSphere 40 or Oracle WebLogic 40. Industry standard application software 40 has the capability of implementing load balancing, caching, and failover in accordance with standard industry practice.

When the servers 13 running the application server 40 get overloaded because the e-commerce transactions are coming fast and furious as the result of say, a Superbowl advertisement promotion, the servers 13 fail because they are overloaded. In most cases, the processor 23 is not overloaded, it is the server 13 that runs out of memory that causes the server 13 to crash. The server 13 runs out of memory and crashes, as the processor 13 is running at 31% utilization. They just fall off the edge of a cliff in an unpredictable manner, this is why the administrators back off utilization of servers 13, because they cannot tell when the servers 13 are about to fail.

Note that the server 13 processing memory allocation criteria can be controlled by a blade server 13. A blade server 13 that uses off the shelf memory allocation algorithms has a configuration process that lets the administrator set different parameters to control the efficiency of operation. Deselecting the checkboxes next to the conditions in the state broadens the memory allocation and activates crosspoint switching 20 in a manageable manner.

As can be seen from the example above, the present invention helps the server 13 to quickly obtain more memory 21 resource from a dedicated pool, use the RAM memory 21 to perform a Web service related task by means of a processor 23, and release the allocated memory 21 once the task is complete. The server 13 does have expanded capability to manage the typical spiky workloads coming in from the Internet without crashing. Because the system provides the available RAM memory 21 on an as needed basis, the server 13 is not locked into a rigid single server 13 situation, instead able to leverage a hierarchy of memory blocks that can be allocated on as needed basis. Because the user can implement a dedicated blade server 13 that partitions the memory 21 in any way that is efficient. During a processing 23 task, the server 13 can provide an intuitive system to ensure the success of the search. If the server 13 hits a dead end instead of crashing, the server 13 is able to opt out of trouble by failing over to the shared memory 21 on a backplane 11.

What is claimed is:

1. An invention that makes it possible for distributed servers to be able to share memory efficiently. The invention seeks to facilitate processing of information at full 100% utilization of each server processor instead of the 10% server processor utilization that is common in the IT industry now, creating a Microsoft OS mainframe class computer able to handle shared workload more effectively. The invention thereby changes distributed servers into a mainframe class-computing environment. It thereby makes it possible to decrease the number of servers needed by a factor of ten, saving server purchasing costs, electricity operating costs, software costs, and labor costs. A further advantage of the invention is that it supports green initiatives as data centers account for 27% of the world's electricity usage, potentially reducing that to a smaller proportion of overall worldwide energy usage.
An apparatus consisting of random access memory on a PC board or boards interconnected to multiple discrete servers to achieve shared memory across servers and server configurations. The servers may be standalone, in a functional cluster or clusters, they may be virtualized, they may be implemented as racks of servers or as blade chasses, but what distinguishes them is that they are distributed servers, not mainframe servers.
1. An apparatus of claim 1 of with connection of servers to shared memory on a backplane.
2. An apparatus of claim 1 of with interconnection of servers to shared memory occurring via crosspoint switches, optical signal transports, a dynamic memory management processor, backplane transceivers, a memory backplane, and optical connects.
3. An apparatus of claim 2 consisting of optical and digital signal transports to interconnect discrete servers to shared memory.
4. An apparatus of claim 2 consisting of optical to digital signal conversion and digital to optical signal conversion for interconnection to discrete servers to shared memory.
5. An apparatus of claim 3 consisting of interconnection of a large shared memory backplane to a containerized server farm. A backplane is defined in the broadest sense possible, simply a board with a lot of IC components on it.
6. An apparatus of claim 1 consisting of servers using shared memory to achieve mainframe class data processing from standard server units running Microsoft .NET 40 programming environments.
7. An apparatus of claim 1 consisting of servers using shared memory to achieve mainframe class data processing to bring Microsoft operating system environments to mainframe class computing units.
8. An apparatus of claim 1 consisting of servers using shared memory to achieve mainframe class data processing to bring Microsoft Office applications environments to mainframe class computing units.
9. An apparatus of claim 1 consisting of servers using shared memory to achieve mainframe class data processing to bring competitors of Microsoft operating systems and applications environments to mainframe class computing units.
10. An apparatus of claim 1 of switching devices connected to discrete distributed servers, racks, blades, or blade server chassis to facilitate memory sharing between multiple distributed data processors that act as information a way to leverage efficient use of processor capacity in a data center.
11. An apparatus of claim 1 of switching devices connected to discrete distributed servers preconfigured in a truck container and offloaded to a datacenter with the shared memory part of the pre-configuration process processor capacity in a data center.
12. A method of connecting discrete distributed servers preconfigured in a truck container and used in a datacenter with the method of connecting shared memory part of the server pre-configuration process.
13. An apparatus of claim 1 connecting discrete distributed servers preconfigured in a truck container where the memory backplane is mounted on one side of the truck, and used in a datacenter.
14. An apparatus of claim 1 that uses the crosspoint switches and specialized processors on a printed circuit board to differentiate shared application processor memory from cache.
15. An apparatus of claim 1 using a crosspoint switch permitting memory to receive an information stream from a server; perform server processing using backplane memory in combination with the regular internal server memory, wherein the switches permit the most efficient use of the backplane information resources.
16. An apparatus of claim 1 consisting of switching devices connected to a memory management server used for dynamically routing information streams as needed.
17. An apparatus of claim 1 consisting of switching devices connected to a shared memory management server and shared memory used memory management server used for dynamically routing information streams as needed to special security servers.
18. An apparatus of claim 1 consisting of switching devices connected to a shared memory management server and shared memory used for dynamically routing information streams as needed to special database query servers optimized to manage database queries efficiently.
19. An apparatus of claim 1 consisting of switching devices connected to a shared memory via linear data transport lines.
20. An apparatus of claim 1 consisting of switching devices connected to a shared memory via nonlinear data transport lines.
21. The apparatus of claim 1, including a processor that determines shared backplane memory allocation as optimized for particular situations
22. An apparatus of claim 1 consisting of A RAM memory backplane failover system implemented by a bank of crosspoint switches connected on a line to a server processing motherboard and a bank of backplane RAM memory.
